(19) United States
(12) Patent Application Publication
(10) Pub. No.: US 2002/0129737 A1
(43) Pub. Date: Sep. 19, 2002

(54) Aqueous bitumen emulsion of buffered pH

(76) Inventor: Christine Deneuvillers, Saint Maur (FR)

Correspondence Address: LARSON & TAYLOR, PLC, 1199 NORTH FAIRFAX STREET, SUITE 900, ALEXANDRIA, VA, 22314, US

(21) Appl. No.: 10/045,013

(22) Filed: Jan. 15, 2002

(30) Foreign Application Priority Data
Jan. 17, 2001 (FR) 01 00614

(51) Int. Cl. C08L 95/00

(52) U.S. Cl. 106/277

(57) ABSTRACT

Aqueous bitumen emulsion intended for producing cold bituminous mixes and comprising at least one ionic-type surfactant and a continuous aqueous phase with a buffered pH, the pH value of the continuous phase being such that the ionic surfactant is present in its ionized form within the said emulsion.

The present invention relates to aqueous bitumen emulsions intended for the preparation of cold bituminous mixes.

Bituminous mixes are materials resulting from coating an aggregate-type substrate with a hydrocarbon compound, called “binder”, generally based on bitumen.

More specifically, bituminous mixes called “cold” mixes are prepared at a moderate temperature, generally less than or equal to 80° C., as opposed to mixes called “hot” mixes for which the preparation is carried out at a much higher temperature, that is to say generally about 150° C. to 200° C.

The advantage of cold mixes lies in the fact that they do not require aggregates to be heated during their preparation, that they can be obtained from wet aggregates and their methods of preparation are more economical and less polluting than those of hot mixes.

The usual cold coating techniques consist in general in bringing an aqueous emulsion of a hydrocarbon binder, stabilized by the presence of surfactants, at least some of which are of the ionic type, into contact with mineral materials such as aggregates varying in their geological origin (quartzites, diorites, limestones, alluvial materials, etc.).

These emulsions may be called “cationic” or “anionic” emulsions, depending on whether the surfactants used are predominantly cationic surfactants or alternatively predominantly anionic surfactants.

Thus, cationic emulsions are emulsions with a low pH, generally of less than 5, comprising cationic-type surfactants, for example polyamines, polyamidoamines or imidazolines, in their ionized forms, or else quaternary ammonium salts.

As regards anionic emulsions, these are emulsions with a relatively high pH, generally greater than 10, and comprising anionic-type surfactants, such as carboxylates, in their ionized form.

In this type of emulsion, so that the ionic surfactants employed are actually present in their ionized forms, the pH of the aqueous phase is generally changed by using a strong acid (cationic emulsions) or a strong base (anionic emulsions) so as to obtain an aqueous acid phase or an aqueous basic phase, respectively.

During the preparation of a cold mix by using a bitumen emulsion, the addition of a mineral material of the aggregate type leads to a change in the pH of the aqueous phase obtained. This is because the material may contain water, which therefore induces a dilution effect in the aqueous phase. Moreover, the acidic or basic nature of the material used may substantially modify the pH of the aqueous phase.

Thus, if a cationic-type emulsion is used, the introduction of a basic mineral material, of the diorite aggregate type, causes, for example, a substantial increase in the pH of the aqueous phase, generally from a value of between 1.5 and 4 to a value greater than or equal to 6. In the case of anionic-type emulsions, the use of an acid-type material, such as quartzite aggregates, leads to a decrease in the pH of the aqueous phase from a value generally greater than 11 to a value of 7 or less.

In all cases, the change in pH produced generally causes-the emulsion to break. This is because the ionic surfactants present have a tendency both to be adsorbed on the surface of the mineral material introduced and to lose their ionic character due to the effect of the change in pH, which contributes to reducing the stability of the emulsion, on the one hand because the amount of surfactants present at the water/oil interfaces is reduced and on the other hand because the electrostatic repulsive forces between the globules of the emulsion are weakened.

These various phenomena result in interglobular homocoalescence and heterocoalescence processes between the globules and the mineral material introduced. These homocoalescence and heterocoalescence phenomena are at least partly responsible for the coating of the material introduced and therefore for the formation of the bituminous mix.

Nevertheless, in order to achieve optimum coating of the materials and to obtain cold mixes prepared using this type of method which have satisfactory mechanical properties, heterocoalescence of the bitumen globules must be as homogeneous as possible at the surface of the material used.

However, in most cases, the interglobular homocoalescence phenomena associated with the weakening of the repulsion between the emulsion globules are too rapid for the heterocoalescence phenomena to occur homogeneously.

To overcome these difficulties and obtain cold mixes with satisfactory mechanical properties, one method consists in increasing the surfactant content within the bitumen emulsions used, for the purpose of maintaining sufficient stability of the emulsion globules despite the adsorption and neutralization phenomena observed when the mineral material is introduced.

However, it should be noted that the use of emulsions having a high surfactant content is relatively expensive. Moreover, it should also be emphasized that, although the use of emulsions having a high surfactant concentration does in fact lead to a substantial reduction in homocoalescence, it nevertheless quite often leads to the formation of so-called “muddy” cold mixes, with a high water content, which have the appearance of a slurry and are more difficult to compact because of their considerable swelling, which generally makes them unusable in the roadmaking industry. Furthermore, the use of an excess amount of surfactant may also result in some cases in imperfect coating.

However, it has now been discovered that higher quality coating can be achieved without using such an excess of surfactant. This is because the inventors, studies have demonstrated that, surprisingly, the use of bitumen emulsions having an aqueous phase with a buffered pH in the method of preparing a cold mix results, upon introducing a mineral material, in the processes associated with the change in pH being slowed down sufficiently for the said material to be able to be coated homogeneously over the entire surface of all the grading fractions of the material. In other words, the inventors have discovered that the use of an aqueous phase with a buffered pH within the bitumen emulsion makes it possible, when adding the mineral material, to provide a surfactant effect sufficient to allow optimum coating without causing, however, the undesirable effects associated with the use of an excess amount of surfactant.

On the basis of this discovery, one of the objects of the present invention is to provide bitumen emulsions which can, by using a cold-coating method, result in homogeneous and -effective coating of a mineral material.

A second object of the invention is to provide a cold-coating method capable of advantageously replacing the coating techniques which use bitumen emulsions having a high content of surfactants.

Another object of the present invention is to provide bituminous mixes possessing mechanical properties suitable for use in the roadmaking field.

Thus, according to a first aspect, the subject of the present invention is an aqueous bitumen emulsion intended for producing cold bituminous mixes and comprising:

(a) at least one ionic-type surfactant; and

(b) a continuous aqueous phase with a buffered pH, the pH value of the continuous phase (b) being such that the ionic surfactant (a) is present in its ionized form within the said emulsion.

Within the context of the present invention, the term “bitumen” is understood to mean any bitumen-type hydrocarbon binder suitable for use in the roadmaking industry. However, the bitumens used within the emulsion of the invention are generally bitumens characterized by a needle penetration at 25° C. of between 20 and 220 tenths of a millimeter, preferably between 30 and 200 tenths of a millimeter and particularly advantageously between 70 and 180 tenths of a millimeter. It should be recalled that the needle penetration of a bitumen is defined by the depth of penetration of a needle into the bitumen in question, under standardized conditions as defined in the AFNOR EN 1426 standard.

The bitumen emulsions of the invention also have, in the general case, a hydrocarbon binder content of between 50% and 80% by mass, preferably between 60% and 70% by mass, these mass percentages being expressed with respect to the total mass of the emulsion. As regards the water present within the emulsion, this represents, as a general rule, from 20% to 50%, and preferably from 30% to 40%, of the total mass of the emulsion.

The hydrocarbon binder constituting the dispersed phase of the emulsion may include, in addition to the bitumen as defined above, various additives such as diluants or fluxing agents, adhesion promoters, or thickening agents. Where necessary, the bitumen constitutes, however, generally at least 40% by mass and preferably 55% by mass of the dispersed phase.

The exact nature of the surfactants present within the bitumen emulsions of the invention depends both on the hydrocarbon binder employed and the envisaged use of the said emulsion. Consequently, the exact nature of the surfactants used may vary quite widely.

However, one of the major features of the emulsions of the invention is that they specifically contain at least one ionic-type surfactant in its ionized form.

Thus, according to a first variant, the emulsions of the invention may be cationic-type emulsions. In this case, the pH of the continuous phase of the emulsion is generally set at a value of less than 5.5, preferably less than 4 and advantageously between 2.5 and 3.5. The surfactants present within these emulsions then include at least one cationic surfactant in its ionized form, generally chosen from salts of amines, polyamines, polyamidoamines or imidazolines, and preferably, in this case, from salts of tallow polyamines advantageously -consisting of linear or branched carbon chains having between 8 and 22, and preferably between 12 and 18, -carbon atoms. The content of surfactants within the emulsions of the invention is then generally between 2 and 8 kg of surfactant per tonne of emulsion (i.e. between 0.2 and 0.8% by mass) and preferably between 3 and 5 kg per tonne of emulsion (i.e. between 0.3 and 0.5% by mass), which corresponds to relatively low surfactant contents within the context of the preparation of bitumen emulsions.

According to a second variant, the bitumen emulsions of the invention may also be anionic-type emulsions. In this second variant, the pH of the aqueous phase is generally set at a value greater than 10, preferably greater than 11 and advantageously between 11 and 13. The surfactants employed in these emulsions then include at least one anionic surfactant in its ionized form. Preferably, this anionic surfactant is a carboxylate salt, generally containing, as the case may be, between 10 and 20 carbon atoms within its carbon chain. The content of anionic-type surfactants within the emulsions of the invention is then generally between 5 and 14 kg of surfactant per tonne of emulsion (i.e. between 0.5 and 1.4% by mass) and preferably between 6 and 12 kg per tonne (i.e. between 0.6 and 1.2% by mass, which again corresponds to relatively low contents within the field of bitumen emulsions.

Whatever the nature of the emulsion employed, the ionic surfactant may also be a surfactant of the ampholytic or amphoteric type, capable of being ionized depending on the pH of the medium in order to form either a cationic surfactant (at a pH below the isoelectric point) or an anionic surfactant (at a pH above the isoelectric point).

Moreover, the ionic surfactant (a) present within the emulsions of the invention may also be used with other ionic surfactants, or else with nonionic surfactants. Where appropriate, the nonionic surfactants used are advantageously polyethoxylated monoalkyl ethers preferably containing, where appropriate, from 12 to 18 carbon atoms within their alkyl chain and from 2 to 15 ethoxy groups —CH₂CH₂O— within their polyethoxylated part. In general, within the context of the particular use of nonionic surfactants, the total content of ionic and nonionic surfactants is generally between 0.3% and 3% by mass within the emulsion.

In the case of cationic emulsions just as in the case of anionic emulsions, the pH of the continuous aqueous phase of the emulsions of the invention is specifically a buffered pH. The expression “medium with a buffered pH” is understood to mean a medium whose pH varies little, or even not at all, upon moderate dilution or the addition of a relatively small amount of an acidic or basic reactant into the said medium. The specific presence of this aqueous medium with a buffered pH makes it possible, when the emulsion is brought into contact with an aggregate-type material, to slow down the phenomena associated with the change in pH.

In general, the aqueous phase with a buffered pH of the emulsions of the invention advantageously comprises a mixture of a weak acid and a weak base, a mixture of a weak acid and a strong base and/or a mixture of a weak base and a strong acid.

However, the exact nature of the acids and bases present within this buffered aqueous phase has to be tailored, especially according to the nature of the surfactants employed and the specific use envisaged for the emulsion.

Thus, in the case of a cationic-type emulsion according to the invention, the aqueous phase employed generally comprises a weak acid corresponding to an acid-base pair whose pKa is advantageously less than 6 and preferably less than 5, generally in association with its conjugate base and/or with a strong acid, such as hydrochloric acid or sulphuric acid, for example. Advantageously, and most particularly when the surfactant employed is of the amine or polyamine salt, the weak acid used in the aqueous phase with a buffered pH is then chosen from acetic acid, acrylic acid, benzoic acid, formic acid, glycolic acid and terephthalic acid.

Likewise, in the case of an anionic-type emulsion according to the invention, the aqueous phase with a buffered pH generally comprises a weak base corresponding to an acid-base pair whose pKa is greater than 10 and preferably greater than 11, preferably in association with its conjugate acid and/or with a strong base of the sodium hydroxide or potassium hydroxide type for example. Preferably, and in particular when the anionic surfactant employed is of the carboxylate salt type, the weak base used within the aqueous phase of the emulsion is then chosen from benzylamine, diethylamine and triethylamine.

In general, the buffered pH of the aqueous phase may also be set by using any type of standard buffer solution such as, for example, hydrochloric acid/glycine, citric acid/sodium hydroxide or citric acid/sodium phosphate buffers, insofar as the use of such a buffer leads to a pH value being obtained such that the ionic surfactant present is indeed in its ionized form within the emulsion formed.

The various concentrations of the acids and bases present within the aqueous phase of the emulsions of the invention may vary quite widely, provided that their respective proportions result in a pH being obtained at which the ionic surfactants present are actually in their ionized form.

However, it should be emphasized that, the higher these concentrations, the more stable the pH by the buffering effect when these emulsions are brought into contact with an aggregate-type mineral material. The various concentrations of acids and bases used must therefore be high enough to ensure suitable stabilization during coating. However, it should also be noted that the use of emulsions having a high content of acids and/or bases may also result in high costs.

Taking these various points into consideration, it is within the competence of a person skilled in the art to tailor the concentrations to be used within a particular emulsion, depending on the type of material that it is desired to coat by the use of this emulsion, by establishing an acceptable compromise between the stabilization achieved in the presence of the said material and the cost associated with the use of the amount of buffer employed.

Thus, within the context of a cationic emulsion according to the invention, intended for coating a material having a highly basic tendency, such as a calcareous material, the concentrations used must, for example, be greater than those used within the context of the coating of a less basic material, such as an alluvial siliceous limestone.

Likewise, an anionic emulsion according to the invention must be more greatly stabilized by the buffering effect when the material that it is intended to coat has a pronounced acidic character.

The bitumen emulsions of the invention may be prepared using any standard method of preparing bitumen emulsion known in the prior art. The sole difference existing over the standard preparation methods is that the aqueous phase used is specifically an aqueous phase with a buffered pH.

According to another aspect, the subject of the present invention is also the use of the emulsions described above for preparing a cold bituminous mix.

As a general rule, the bitumen emulsions of the invention may advantageously replace the standard bitumen emulsions in the known cold-coating methods of the prior art. This is because the bitumen emulsions of the invention can be used in these methods under the same operating conditions as the emulsions of unstabilized pH, while ensuring, moreover, higher quality of coating because the pH has been stabilized by the buffering effect upon contact with an aggregate-type mineral material.

However, the bitumen emulsions of the invention are advantageously used in methods requiring effective stabilization of the pH by a buffering effect.

Consequently, the methods involving the emulsions of the invention generally include a step consisting in bringing a cationic-type emulsion, as defined above, into contact with a mineral material of basic character or a step consisting in bringing an anionic-type emulsion, as defined above, into contact with a mineral material of acidic character.

According to a final aspect, the subject of the invention is also the cold bituminous mixes obtained by using a bitumen emulsion having an aqueous phase with a buffered pH according to the invention.

Because the pH is stabilized by the effect of the buffer within the aqueous phase of the emulsions of the invention, the cold bituminous mixes obtained by using these emulsions of stabilized pH have in general a high level of coating, generally greater than 90%, or even 95%. Under certain conditions, the use of an aqueous phase with a buffered pH within the bitumen emulsion even allows 100% coating levels to be achieved. These various coating levels are expressed, in the case of the mixes obtained, by the ratio of the surface area of the coated material actually covered with the hydrocarbon binder to the total surface area of the material.

Moreover, especially if the emulsions of the invention do not have too high a surfactant content, the cold mixes obtained by using these emulsions are generally easily compactable and possess, in general, beneficial mechanical properties especially in terms of compressive strength. In particular, it should be noted that the cold mixes obtained by using the bitumen emulsions of the invention generally possess mechanical properties at least equal, or even superior to those obtained by the methods using bitumen emulsions having a high surfactant content.

The features and advantages of the bitumen emulsions of the present invention and of the cold bituminous mixes obtained by using these emulsions will become more clearly apparent from the particular illustrative examples explained below.

### EXAMPLE 1

### Cationic emulsions

Various cationic-type bitumen emulsions were produced by a method consisting in dispersing a hydrocarbon binder consisting of a straight-run refinery bitumen of 160/200 class (that is to say characterized by a needle penetration at 25° C. of between 160 and 200 tenths of a millimeter) in an aqueous dispersing phase, by emulsification in an Atomix-type turbine under the following conditions:

| | |
|---|---|
| initial temperature of the bitumen: | 130-140° C. |
| initial temperature of the aqueous phase: | 50-60° C. |

The compositions of these various bitumen emulsions 1a, 1b, 1c and 1d are listed in Table I below, in which the percentages indicated correspond to mass percentages expressed with respect to the total mass of the emulsion.

TABLE I
Cationic emulsions

| Emulsion | 1a | 1b | 1c | 1d |
|---|---|---|---|---|
| Hydrocarbon binder (160- | 60% | 60% | 60% | 60% |
| 200 class bitumen) | | | | |
| Surfactant: tallow | 0.8% | 0.4% | 0.4% | 0.6% |
| polyamine (POLYRAMS- | | | | |
| CECA) | | | | |
| 32% aqueous HCl solution | 0.8% | 0.4% | — | — |
| 90% aqueous acetic acid | — | — | 1.3% | 1.3% |
| solution | | | | |
| Sodium hydroxide | — | — | 0.4% | 0.4% |
| Water | qsp | qsp | qsp | qsp |
| | 100% | 100% | 100% | 100% |
| Initial pH of the | 2.2 | 2.4 | 4.9 | 5.0 |
| aqueous phase | | | | |
| pH of the emulsion | 2.5 | 3.8 | 4.9 | 5.0 |
| Mean bitumen-globule | 5.1 μm | 5.2 μm | 3.1 μm | 3.0 μm |
| diameter (determined by | | | | |
| LASER COULTER LS 130 | | | | |
| particle size analysis) | | | | |

Emulsions 1a, 1b, 1c and 1d were used in a cold-coating method with various mineral materials by mixing, for one minute at 20° C. in an “Angers”-type mixer, a mixture having the following composition:

| | |
|---|---|
| material: | 100 parts by weight |
| emulsion: | 7 parts by weight |
| | (including 4.2 parts of |
| | hydrocarbon binder) |
| water of addition: | amount such that the total water |
| | content in the mixture is 5 parts |
| | by weight. |

The various coating levels obtained depending on the emulsion and on the mineral material used are indicated in Table II below.

TABLE II
Coating levels obtained by using cationic emulsions

| | | Bitumen emulsion used | | | |
|---|---|---|---|---|---|
| | | 1a | 1b | 1c | 1d |
| Coated | Diorite* | 100% | 75% | 90% | 100% |
| mineral | Quartzite* | 90% | 90% | 90% | 100% |
| material | Alluvial | 90% | 50% | 90% | 100% |
| | siliceous | | | | |
| | limestone* | | | | |
| | Limestone* | 95% | 75% | 95% | 100% |

*grading: 0/10 as defined in the AFNOR NP P98-121 standard.

The results obtained show indeed that the use of bitumen emulsions with a pH stabilized by a buffering effect (Emulsion 1c or 1d) result in coating levels which are equivalent to, or even higher than, those obtained by using an emulsion having a higher surfactant content but with a non-stabilized pH of the Emulsion 1a type.

Moreover, it should also be noted that Emulsion 1d with a pH stabilized by the acetic buffer makes it possible to achieve 100% coating of the quartzite and of the alluvial material, whereas such a coating level is not obtained without the pH being stabilized, even in the case of the use of a high surfactant concentration as in Emulsion 1a.

### EXAMPLE 2

### Anionic emulsions

Anionic-type bitumen emulsions were produced, in the same way as in the previous example, by a method consisting in dispersing a hydrocarbon binder consisting of a straight-run refinery bitumen of 160/200 class in an aqueous dispersing phase, by emulsification in an Atomix-type turbine under the following conditions:

initial temperature of the bitumen: 130-140° C.

initial temperature of the aqueous phase: 50-60° C.

The compositions of these bitumen emulsions, labelled 2a, 2b, 2c and 2d are listed in Table III below (the contents indicated represent percentages expressed in percentages by mass with respect to the total mass of the emulsion).

TABLE III
Anionic emulsions

| Emulsion | 2a | 2b | 2c | 2d |
|---|---|---|---|---|
| Hydrocarbon binder (160- | 60% | 60% | 50% | 60% |
| 200 class bitumen) | | | | |
| Amphoteric surfactant* | 0.8% | 1.2% | 0.8% | 0.6% |
| 5 mol/litre aqueous | 1.05% | 1.15% | — | — |
| sodium hydroxide | | | | |
| solution | | | | |
| Basic buffer** (pH = 10) | — | — | — | 1.0% |
| Water | qsp | qsp | qsp | qsp |
| | 100% | 100% | 100% | 100% |
| pH of the emulsion | 12.5 | 12.5 | 9 | 10 |

*: EN1009 surfactant sold by Akzo;
**: NORMADOSE buffer sold by Prolabo.

Various cold mixes were then made by using these anionic emulsions in a method consisting in mixing, for one minute at 20° C. in an “Angers”-type mixer, a mixture having the following composition:

| | |
|---|---|
| material: | 100 parts by weight |
| emulsion: | 7 parts by weight |
| | (including 4.2 parts of binder) |
| water of addition: | amount such that the total water |
| | content in the mixture is 5 parts |
| | by weight. |

The coating levels obtained are listed in Table IV below.

TABLE IV
Observed coating levels when anionic emulsions are used

| | | Anionic emulsion used | | | |
|---|---|---|---|---|---|
| | | 2a | 2b | 2c | 2d |
| Coated | Quartzite* | 40% | — | 20% | 60% |
| mineral | Alluvial | 50% | 100% | 40% | 100% |
| material | siliceous | | | | |
| | limestone* | | | | |

*grading: 0/10 as defined in the AFNOR NF P98-121 standard.

The results obtained show that, in the case of anionic emulsions, an emulsion whose pH of the aqueous phase is stabilized by a buffering effect (Emulsion 2d) results in effective coating, if not more effective than that observed with emulsions having higher surfactant contents (Emulsions 2a, 2b and 2c).

### EXAMPLE 3

### Mechanical properties (compressive strength) of mixes obtained from cationic-type bitumen emulsions

The cold mixes obtained from Emulsions 1a, 1b, 1c and 1d of Example 1 were subjected to a Duriez test for characterizing the compressive strength with and without a period of immersion, according to the NF P 98-251-4 standard.

In brief, it will be recalled that this test consists in measuring the compressive strength R of a cold mix after 14 days of dry maturing at 18° C. and at 50% relative humidity and the compressive strength r of the same cold mix after 7 days of dry maturing at 18° C. and at 50% relative humidity and 7 days of immersion in water at 18° C. It is generally considered that a cold mix exhibits satisfactory mechanical properties in terms of compression strength if the r/R ratio is greater than 0.55 (NF P 98-121 standard).

The results obtained with the cationic emulsions of Example 1 are given in Table V below.

TABLE V
Duriez compressive strength results observed
for various cold mixes obtained using cationic
emulsions

| Cationic emulsion used | 1a | 1b | 1c | 1d |
|---|---|---|---|---|
| Duriez compressive | 5.4 | 4.8 | 5.2 | 6.1 |
| strength R after 14 days | | | | |
| at 18° C./50% RH (in MPa) | | | | |
| Duriez compressive | 4.7 | 4.0 | 4.4 | 5.4 |
| strength r after 7 days | | | | |
| at 18° C./50% RH + 7 days | | | | |
| immersion at 18° C. | | | | |
| (in MPa) | | | | |
| r/R | 0.88 | 0.84 | 0.85 | 0.89 |

The tests carried out clearly show that the mechanical properties obtained for a cold mix prepared from a cationic emulsion with a pH stabilized by a buffering effect are equivalent, if not superior, to those obtained by using cationic emulsions having a higher surfactant content.

1. Aqueous bitumen emulsion intended for producing cold bituminous mixes and comprising:
(a) at least one ionic-type surfactant; and
(b) a continuous aqueous phase with a buffered pH, the pH value of the continuous phase (b) being such that the ionic surfactant (a) is present in its ionized form within the said emulsion.

2. Emulsion according to claim 1, characterized in that the hydrocarbon binder present within the said emulsion represents from 50% to 80% of the total mass of the emulsion and in that the water present within the emulsion represents from 20% to 50% of the total mass.

3. Emulsion according to claim 1, characterized in that the ionic surfactant (a) present within the emulsion in its ionized form is a cationic-type surfactant and in that the value of the buffered pH of the aqueous phase is less than 5.5.

4. Emulsion according to claim 3, characterized in that the cationic-type surfactant used is an amine, polyamine, polyamidoamine or imidazoline salt.

5. Emulsion according to claim 3, characterized in that the content of cationic-type surfactant is between 0.2 and 0.8% by mass.

6. Emulsion according to claim 3, characterized in that the aqueous phase comprises a weak acid corresponding to an acid-base pair whose pKa is less than 6, together with its conjugate base and/or with a strong acid.

7. Emulsion according to claim 6, characterized in that the said weak acid is chosen from acetic acid, acrylic acid, benzoic acid, formic acid, glycolic acid and terephthalic acid.

8. Emulsion according to claim 1, characterized in that the ionic surfactant (a) present within the emulsion in its ionized form is an anionic-type surfactant and in that the value of the buffered pH of the aqueous phase is greater than 10.

9. Emulsion according to claim 8, characterized in that the anionic-type surfactant used is a carboxylate salt.

10. Emulsion according to claim 8, characterized in that the content of anionic-type surfactant is between 0.5 and 1.4% by mass.

11. Emulsion according to claim 8, characterized in that the aqueous phase comprises a weak base corresponding to an acid-base pair whose pKa is greater than 10, together with its conjugate acid and/or with a strong base.

12. Emulsion according to claim 11, characterized in that the said weak base is chosen from benzylamine, diethylamine and triethylamine.

13. Use of an emulsion according to claim 1 for preparing a cold bituminous mix.

14. Method of preparing a cold bituminous mix, comprising a step consisting in bringing a cationic emulsion according to claim 3 into contact with a mineral material of basic character.

15. Method of preparing a cold bituminous mix, comprising a step consisting in bringing an anionic emulsion according to claim 8 into contact with a mineral material of acidic character.

16. Cold bituminous mix obtained by a method according to claim 14 or by using a bitumen emulsion according to claim 1 in a cold-coating method consisting in bringing the said emulsion into contact with an aggregate-type mineral material.

17. Cold bituminous mix obtained by a method according to claim 15 or by using a bitumen emulsion according to claim 1 in a cold-coating method consisting in bringing the said emulsion into contact with an aggregate-type mineral material.
